(19) United States
(12) Patent Application Publication
(10) Pub. No.: US 2018/0260699 A1
(43) Pub. Date: Sep. 13, 2018

(54) TECHNOLOGIES FOR DEEP MACHINE LEARNING WITH CONVOLUTIONAL NEURAL NETWORKS AND REDUCED SET SUPPORT VECTOR MACHINES

(71) Applicant: Intel IP Corporation, Santa Clara, CA (US)

(72) Inventors: Koba Natroshvili, Waldbronn (DE); Kay-Ulrich Scholl, Karlsbad (DE)

(21) Appl. No.: 15/456,918

(22) Filed: Mar. 13, 2017

(51) Int. Cl. G06N 3/08

(52) U.S. Cl. CPC G06N 3/08; G06N 3/088

(57) ABSTRACT

Technologies for machine learning with convolutional neural networks (CNNs) and support vector machines (SVMs) include a computing device that may train a deep CNN on a training data set to recognize features of the training data set. The computing device processes the training data set with the CNN after training to extract feature vectors. The computing device trains a multiclass SVM on the feature vectors. The computing device may train a CNN on a training data set to classify the training data set. After training, the computing device may exchange a layer of the CNN with a multiclass SVM. The computing device may use the weights of the exchanged layer to generate the SVM. The computing device may convert the multiclass SVM to a series of binary SVMs. The computing device may generate a reduced set model for each of the binary SVMs. Other embodiments are described and claimed.

### BACKGROUND

Typical computing devices may use deep learning algorithms, also known as artificial neural networks, to perform object detection, object recognition, speech recognition, or other machine learning tasks. Convolutional neural networks (CNNs) are a biologically inspired type of artificial neural network. Typical CNNs may include multiple convolution layers and/or pooling layers, and a nonlinear activation function may be applied to the output of each layer. Typical CNNs may also include one or more fully-connected layers to perform classification. Those fully connected layers may be linear.

Support vector machines (SVMs) are a supervised machine learning technique that may be used for classification and regression. An SVM base implementation is made for the binary case. The SVM generates a hyperplane that separates examples of two categories. The hyperplane is generated using a subset of training examples known as support vectors. SVMs are based on robust theory and their results are general, which means that the model is optimum not only for the training data but for the further testing examples. Also, SVMs obtain a global minimum, which has a benefit as compared to other methods which often give local minima.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for machine learning with convolutional neural networks and support vector machines;

FIG. 2 is a simplified block diagram of at least one embodiment of an environment of the computing device of FIG. 1;

FIG. 3 is a simplified flow diagram of at least one embodiment of a method for machine learning with convolutional neural network feature extraction that may be executed by the computing device of FIGS. 1 and 2;

FIG. 4 is a schematic diagram illustrating at least one embodiment of a network topology that may be used by the method of FIG. 3;

FIG. 5 is a simplified flow diagram of at least one embodiment of a method for machine learning with a support vector machine exchanged for a convolutional neural network layer that may be executed by the computing device of FIGS. 1 and 2; and

FIG. 6 is a schematic diagram illustrating at least one embodiment of a network topology that may be used by the method of FIG. 5.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

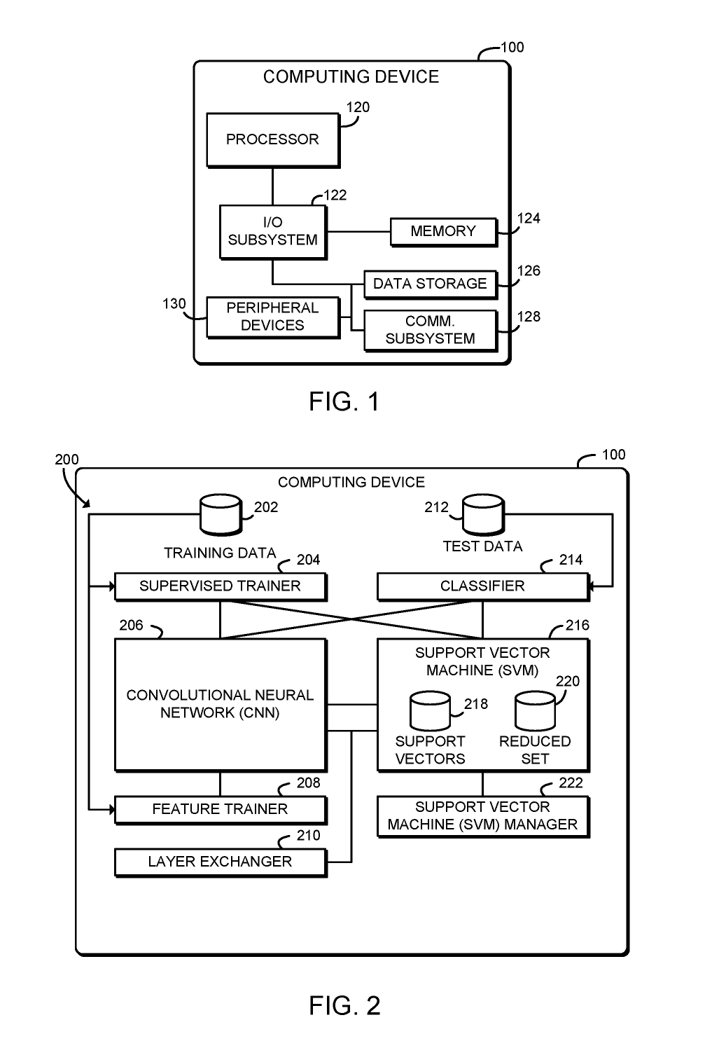

Referring now to FIG. 1, an illustrative computing device 100 for machine learning with convolutional neural networks and support vector machines is shown. In use, as described below, in some embodiments the computing device 100 may train a deep convolutional neural network (CNN) to extract feature vectors from training data, and then train a support vector machine (SVM) using the extracted feature vectors. In the testing phase, the computing device 100 may extract features from test data using the trained CNN and then perform classification using the SVM. To improve testing phase performance, the SVM may be optimized, for example, by generating a reduced set of vectors. Typically, feature vectors for SVM classification are human-generated or otherwise manually identified. Automated feature extraction using the CNN as performed by the computing device 100 may improve classification performance and/or accuracy as compared to manual feature extraction or identification. Additionally, simple optimization methods known for SVMs may be used to improve testing performance, which may improve performance over a CNN approach.

In some embodiments, the computing device 100 may train a deep CNN to classify training data and then exchange a layer of the CNN with an SVM. In the testing phase, the computing device 100 may input test data to the CNN (without the exchanged layer), which outputs data to the SVM for classification. Again, to improve testing phase performance, the SVM may be optimized, for example, by generating a reduced set of vectors. Thus, the computing device 100 may improve classification accuracy by replacing a linear CNN layer (e.g., a fully connected layer) with an SVM, which may be nonlinear (e.g., by using a nonlinear kernel). Additionally, as described above, simple optimization methods known for SVMs may be used to improve testing performance, which may improve performance over a pure CNN approach.

The computing device 100 may be embodied as any type of device capable of performing the functions described herein. For example, the computing device 100 may be embodied as, without limitation, a computer, a workstation, a server, a laptop computer, a notebook computer, a tablet computer, a smartphone, a wearable computing device, a multiprocessor system, and/or a consumer electronic device. As shown in FIG. 1, the illustrative computing device 100 includes a processor 120, an I/O subsystem 122, a memory 124, and a data storage device 126. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 100 such operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 100. For example, the I/O subsystem 122 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 100, on a single integrated circuit chip.

The data storage device 126 may be embodied as any type of device or devices configured for short-term or long-term storage of data such as, for example, memory devices and circuits, memory cards, hard disk drives, solid-state drives, non-volatile flash memory, or other data storage devices. The data storage device 126 may store training data, test data, model files, and other data used for deep learning.

The computing device 100 may also include a communications subsystem 128, which may be embodied as any communication circuit, device, or collection thereof, capable of enabling communications between the computing device 100 and other remote devices over a computer network (not shown). The communications subsystem 128 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication.

The computing device 100 may further include one or more peripheral devices 130. The peripheral devices 130 may include any number of additional input/output devices, interface devices, and/or other peripheral devices. For example, in some embodiments, the peripheral devices 130 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

Referring now to FIG. 2, in an illustrative embodiment, the computing device 100 establishes an environment 200 during operation. The illustrative environment 200 includes a supervised trainer 204, a convolutional neural network (CNN) 206, a feature trainer 208, a layer exchanger 210, a classifier 214, a support vector machine (SVM) 218, and an SVM manager 222. The various components of the environment 200 may be embodied as hardware, firmware, software, or a combination thereof. As such, in some embodiments, one or more of the components of the environment 200 may be embodied as circuitry or a collection of electrical devices (e.g., supervised trainer circuitry 204, CNN circuitry 206, feature trainer circuitry 208, layer exchanger circuitry 210, classifier circuitry 214, SVM circuitry 216, and/or SVM manager circuitry 222). It should be appreciated that, in such embodiments, one or more of the supervised trainer circuitry 204, the CNN circuitry 206, the feature trainer circuitry 208, the layer exchanger circuitry 210, the classifier circuitry 214, the SVM circuitry 216, and/or the SVM manager circuitry 222 may form a portion of the processor 120, the I/O subsystem 122, and/or other components of the computing device 100 (e.g., a GPU or processor graphics in some embodiments). Additionally, in some embodiments, one or more of the illustrative components may form a portion of another component and/or one or more of the illustrative components may be independent of one another.

As shown, the environment 200 includes the CNN 206 and the SVM 216. The CNN 206 may be embodied as a deep neural network that includes multiple network layers, such as convolution layers, fully connected layers, pooling layers, activation layers, and other network layers. The SVM 216 may be embodied as a decision function and a model. The model includes multiple vectors and associated weights. The SVM 216 algorithm is based on structural risk minimization, and generates a separating hyperplane based on the model to separate class members from non-class members. The model may be embodied as support vectors 218, which are a subset of the training data used to train the SVM 216. For improved performance, the model may be embodied as reduced set vectors 220, which are a smaller number of vectors that may be used to generate a similar (or in some embodiments identical) hyperplane. Each reduced set vector 220 is generated and thus may not be included in the support vectors 218 and/or the training data. The SVM 216 may be embodied as a multiclass SVM and/or an equivalent series of binary SVMs.

The SVM manager 222 is configured to convert a multiclass SVM 216 to a series of binary SVMs 216. The SVM manager 222 may be further configured to reduce a size of each of the feature vectors. The SVM manager 222 may be further configured to generate a reduced set 220 for each binary SVM 216.

The feature trainer 208 is configured to train the CNN 206 on a training data set (e.g., training data 202) to recognize features of the training data set. The training data 202 may be embodied as image data, speech recognition data, or other sample input data. The training data 202 may include classification labels for supervised training. Training the CNN 206 may include performing unsupervised feature learning on the training data set. The feature trainer 208 is further configured to process the training data set with the CNN 206 to extract feature vectors based on the training data set.

The supervised trainer 204 may be configured to train a multiclass SVM 216 on the feature vectors to classify the training data set. The multiclass SVM 216 may be trained after reducing the size of each feature vector as described above.

The classifier 214 may be configured to process a test data item (e.g., an item of test data 212) with the CNN 206 to extract a test feature vector based on the test data item after training of the CNN 206. The test data item may be embodied as an image, speech recognition sample, or other data to be classified. The classifier 214 may be further configured to process the test feature vector with the series of binary SVMs 216 and classify the test data item in response to processing of the test feature vector.

In some embodiments, the supervised trainer 204 may be configured to train the CNN 206 on a training data set (e.g., the training data 202) to classify the training data set. The layer exchanger 210 is configured to exchange one or more network layers of the CNN 206 with the multiclass SVM 216 after training the CNN 206. The layer exchanger 210 may be configured to generate an exchanged CNN 206′ that does not include the exchanged layer. The layer may be embodied as a fully connected layer, a convolution layer, or other network layer of the CNN 206. Exchanging the layer with the multiclass SVM 216 may include generating the multiclass SVM 216 using the trained weights of the network layer. In some embodiments, exchanging the layer with the multiclass SVM 216 may include training the multiclass SVM 216 on an output of the exchanged CNN 206′ to classify the training data set.

The classifier 214 may be configured to process a test data item (e.g., an item of the test data 212) with the exchanged CNN 206′ and the series of binary SVMs 216. The classifier 214 may be further configured to classify the test data item in response to processing of the test data item.

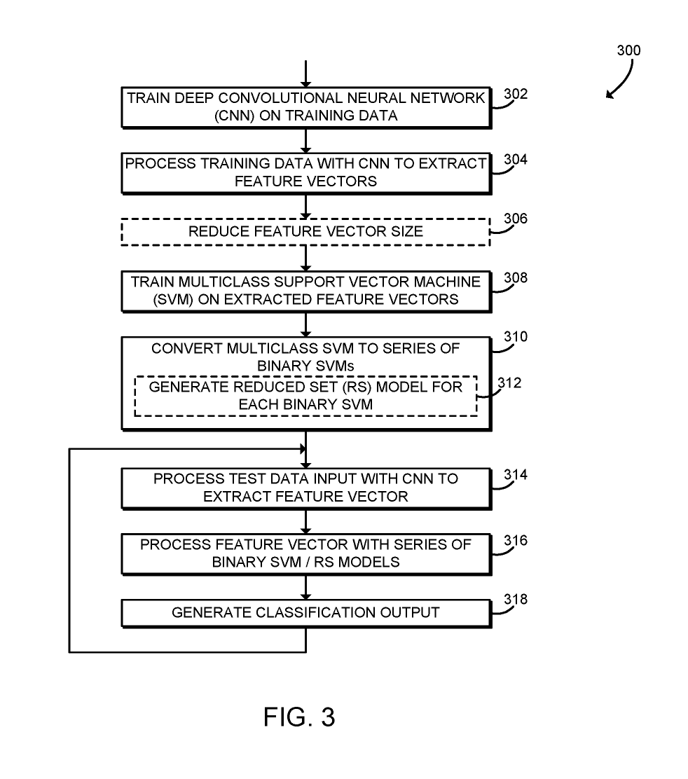

Referring now to FIG. 3, in use, the computing device 100 may execute a method 300 for machine learning with convolutional neural network feature extraction. It should be appreciated that, in some embodiments, the operations of the method 300 may be performed by one or more components of the environment 200 of the computing device 100 as shown in FIG. 2. The method 300 begins in block 302, in which the computing device 100 trains a deep convolutional neural network (CNN) 206 on training data 202. The CNN 206 includes multiple network layers, such as one or more convolution layers, pooling layers, activation layers, and/or fully connected layers. In a convolution layer, the input data (e.g., images) are convolved with different kernel filters, which may, for example, extract different types of visual features from input images while guaranteeing rotational symmetry of the features. A pooling layer performs downsampling of the input data, for example by downscaling the image or modifying convolution kernels. Pooling may make perception field scaling invariant. An activation layer passes the input data through an activation function, such as a rectified linear unit (ReLU), which provides nonlinearity to the CNN 206. The CNN 206 may include one or more fully connected layers that compute one or more class scores for the input data.

The training data 202 may be embodied as image data, speech data, or other training data. As described further below, the training data 202 may be labeled with one or more classes for supervised learning. The CNN 206 is trained to recognize features in the training data 202. For example, the CNN 206 may be trained using an unsupervised feature learning algorithm to identify features in the training data 202. Training results in weights being assigned to the neurons (or units) of the CNN 206. In some embodiments, the same weights may be shared between several layers to save calculation time. After training, neurons that are more important for recognizing features in the training data 202 are assigned higher weights. Thus, features may be selected using a weight analysis, by assigning features with higher weights higher priority. The features may also be distributed in different layers of the CNN 206 using a predetermined distribution.

In block 304, the computing device 100 processes the training data 202 with the trained CNN 206 to extract feature vectors from the training data 202. The feature vectors may be embodied as the values output from one or more layers of the CNN 206. Each of the feature vectors is thus a representation of the input data that prioritizes features corresponding to neurons with higher weights. As an example, in an embodiment where the CNN 206 includes a convolution layer that includes 100 neurons, each feature vector may be embodied as a vector with 100 attributes, where each attribute is the output of a corresponding neuron of the convolution layer.

In block 306, in some embodiments the computing device 100 may reduce the feature vector size. For example, the computing device 100 may reduce the number of attributes in each feature vector. The computing device 100 may use any technique to reduce the feature vector size. For example, the computing device 100 may perform principal component analysis to reduce the feature vector size. Reducing the feature vector size may improve training and testing performance of the SVM 216.

In block 308, the computing device 100 trains a multiclass support vector machine (SVM) 218 on the extracted feature vectors. The training generates a set of support vectors 218 that may be used to generate a hyperplane to separate class members from non-class members. Each of the support vectors 218 is a feature vector that corresponds to an item in the training data 202. In block 310, the computing device 100 converts the multiclass SVM 216 into a series of binary SVMs 216. Each binary SVM 216 makes a single classification decision, for example using the “one against all” or the “one against one” techniques.

The SVM decision function ƒ(x) for the testing phase for each binary SVM 216 is shown in Equation 1. In Equation 1, Nₛ is the number of support vectors 218. The value yᵢ is the class label. For example, for a binary SVM with two classes, yᵢ may be equal to −1 or 1. The value αᵢ is the weight for the corresponding support vector 218. The function K(x,sᵢ) is the kernel function, which converts vector input into a scalar product. Kernel functions used by the SVM 216 may be, for example, polynomial, radial, or sigmoid, and may be user-defined. The vector x is the input data to be classified (e.g., an item from the test data 212 as described further below), and the vector sᵢ is a support vector 218. Each support vector 218 is a feature vector that corresponds to an item in the training data 202. The support vectors are usually close to the decision hyperplane. The value b is a constant parameter. Thus, training the SVM 216 identifies the support vectors 218 (i.e., identifies support vector sᵢ for i=0 to Nₛ) as well as a weight αᵢ for each support vector sᵢ, and the parameter b.

$$f ( x ) = sgn ( {\sum }_{i = 1}^{{N}_{s}} {y}_{i} {α}_{i} K ( x , {s}_{i} ) + b ) \qquad ( 1 )$$

In some embodiments, in block 312, the computing device 100 may generate a reduced set 220 of vectors for each binary SVM 216. The reduced set 220 includes vectors that may be used to generate a hyperplane to separate class members from non-class members, similar to the support vectors 218. However, each vector of the reduced set 220 is not included in the training data 202 (i.e., is not a feature vector corresponding to an item of the training data 202). The hyperplane generated by the reduced set 220 may be similar to, or in some embodiments identical to, the hyperplane generated by the support vectors 218. Because the reduced set 220 may include a much smaller number of vectors than the support vectors 218, test phase performance with the reduced set 220 may be significantly higher than with the support vectors 218.

The SVM decision function ƒ(x) for the testing phase for each binary SVM 216 using the reduced set 220 is shown in Equation 2. As shown, the actual computation of Equation 2 is similar to the computation of Equation 1, above. In Equation 2, N_{z} is the number of vectors in the reduced set 220. The value yᵢ is the class label, as described above. The value α^{RedSet}ᵢ is the weight for the corresponding reduced-set vector 220. The function K(x,zᵢ) is the kernel function, as described above. The vector x is the input data to be classified, as described above, and the vector zᵢ is a reduced set vector 220. The value b is the constant parameter, as described above. Thus, generating the reduced set 220 identifies the reduced set vectors 220 (i.e., identifies reduced set vector zᵢ for i=0 to N_{z}) as well as a weight α^{RedSet}ᵢ for each reduced set vector zᵢ.

$${f}_{RedSet} ( x ) = sgn ( {\sum }_{i = 1}^{{N}_{z}} {y}_{i} {α}_{i}^{RedSet} K ( x , {z}_{i} ) + b ) \qquad ( 2 )$$

The computing device 100 may use any appropriate algorithm to generate the reduced set 220. For example, in some embodiments the computing device 100 may use the Burges Reduced Set Vector Method (BRSM), which is described in Chris J. C. Burges, Simplified Support Vector Decision Rules, 13 Proc. Int'l Conf. on Machine Learning 71 (1996). The BRSM is only valid for second order homogeneous kernels as shown in Equation 3.

K(xᵢ,xⱼ)=(αxᵢxⱼ)² (3)

To perform the BRSM, a new S_{μv} matrix is calculated as shown in Equation 4. In Equation 4, s_{iμ} is the matrix of support vectors 218, where i is the index of the support vector 218 and μ is the index of the attributes of the feature vectors. As the next step, eigenvalue decomposition of S_{μv} is performed. This assumes that S_{μv} has N_{z} eigenvalues. Generally, N_{z} will be equal to the feature vector size. The eigenvectors zᵢ of the matrix S_{μv} are the reduced set vectors 220. The eigenvalues are the weighing factors of the reduced set vectors 220. If the number of new reduced set vectors 220 is equal to the dimension of the feature vector, then the reduced set vectors 220 exactly emulate the original classification hyperplane (from the support vectors 218). Thus, the number of reduced set vectors 220 may be reduced to the size of the feature vector with no degradation in classification performance

$${S}_{μ v} ≡ {\sum }_{i = 1}^{{N}_{s}} {α}_{i} {y}_{i} {s}_{i μ} {s}_{iv} \qquad ( 4 )$$

After generating the binary SVMs 216 (and/or generating the reduced set 220), training is complete and the method 300 may enter the testing phase. In block 314, the computing device 100 processes test data 212 with the CNN 206 to extract one or more feature vectors. For example, the CNN 206 may generate a feature vector for each input image, speech sample, or other item of the test data 212. The CNN 206 processes the input data using the weights determined during training as described above in connection with block 302 and generates a feature vector. In some embodiments, the size of the feature vector may then be reduced as described above in connection with block 306.

In block 316, the computing device 100 processes each feature vector with the series of binary SVMs 216 (using the support vectors 218 or the reduced set 220). The computing device 100 may perform the calculation of Equation 1 (for the support vectors 218) or Equation 2 (for the reduced set 220), and the result may identify whether or not the input data item is included in a corresponding class. The computing device 100 may calculate the decision function for multiple binary SVMs 216 in order to support multiclass output. In block 318, the computing device 100 generates classification output based on the output of the SVMs 216. The computing device 100 may, for example, identify a single class or otherwise process the output from the series of binary SVMs 216. After generating the classification output, the method 300 loops back to block 314 to continue processing test data 212. Of course, it should be understood that the method 300 may loop back to block 302 or otherwise restart to perform additional training.

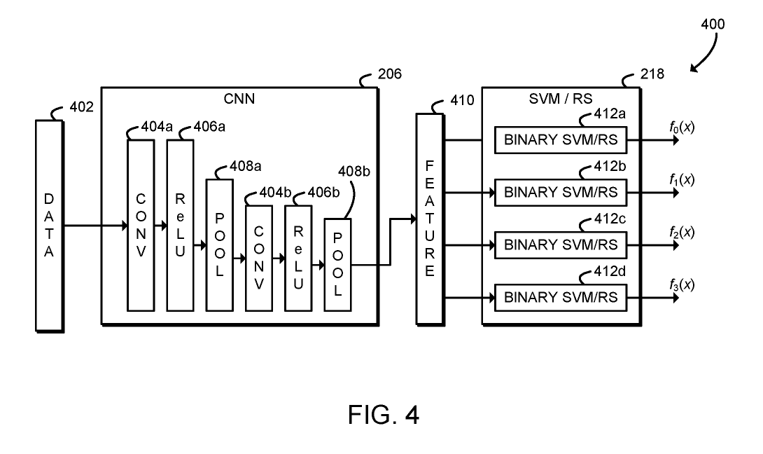

Referring now to FIG. 4, diagram 400 illustrates a network topology that may be used with the method 300 of FIG. 3. The diagram 400 illustrates data 402 that is input to the CNN 206. The data 402 may include the training data 202 as described above in connection with block 304 of FIG. 3 or the test data 212 as described above in connection with block 314 of FIG. 3, depending on the usage phase. As shown, the illustrative CNN 206 is a multi-layer convolutional network including two convolution layers 404a, 404b, two ReLU activation layers 406a, 406b, and two pooling layers 408a, 408b. Of course, in other embodiments the CNN 206 may include a different number and/or type of layers (e.g., the CNN 206 may also include one or more fully connected layers). As described above, the data 402 is input to the CNN 206, and the CNN 206 outputs a feature vector 410. The feature vector 410 is input to the SVM 216. The feature vector 410 may be used for training the SVM 216 as described above in connection with block 308 of FIG. 3 or for the test phase as described above in connection with block 316 of FIG. 3. As shown, the SVM 216 includes a series of binary SVMs and/or reduced set (RS) models 412. As described above, each binary SVM/RS model 412 processes a set of support vectors 218 or reduced set vectors 220 to classify the input feature vector. Each binary SVM/RS model 412 outputs a corresponding decision function ƒᵢ(x), where x is the input data 402.

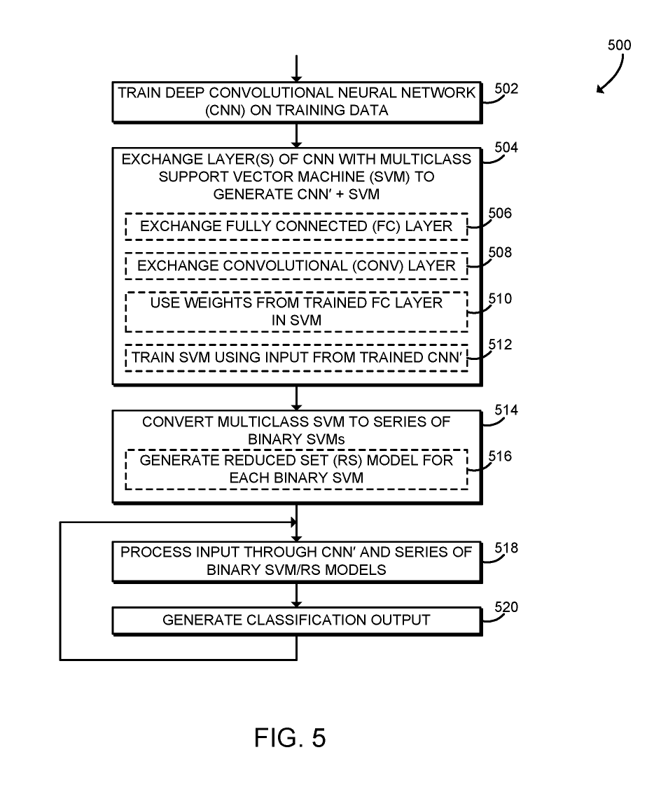

Referring now to FIG. 5, in use, the computing device 100 may execute a method 500 for machine learning with a support vector machine exchanged for a convolutional neural network layer. It should be appreciated that, in some embodiments, the operations of the method 500 may be performed by one or more components of the environment 200 of the computing device 100 as shown in FIG. 2. The method 500 begins in block 502, in which the computing device 100 trains a deep convolutional neural network (CNN) 206 on training data 202. The CNN 206 includes multiple network layers, such as one or more convolution layers, pooling layers, activation layers, and/or fully connected layers. In a convolution layer, the input data (e.g., images) are convolved with different kernel filters, which may, for example, extract different types of visual features from input images while guaranteeing rotational symmetry of the features. A pooling layer performs downsampling of the input data, for example by downscaling the image or modifying convolution kernels. Pooling may make perception field scaling invariant. An activation layer passes the input data through an activation function, such as a rectified linear unit (ReLU), which provides nonlinearity to the CNN 206. The CNN 206 may include one or more fully connected layers that compute one or more class scores for the input data. The training data 202 may be embodied as image data, speech data, or other training data. The training data 202 is labeled with one or more classes, and the computing device 100 performs supervised learning on the training data 202 to identify the classes in the training data 202. Training results in weights being assigned the neurons (or units) of the CNN 206.

In block 504, the computing device 100 exchanges one or more layers of the CNN 206 with a support vector machine (SVM) 218. The computing device 100 may generate an exchanged CNN 206′ that does not include the exchanged layer and may be used in the testing phase with the SVM 216 as described further below. In some embodiments, in block 506 the computing device 100 may exchange a fully-connected layer with the SVM 216. For example, the computing device 100 may exchange one or more fully connected layers that perform classification at the end of the CNN 206. The exchanged fully connected layer may be linear (i.e., may not include a nonlinear activation function), and may be exchanged with a nonlinear SVM 216. In some embodiments, in block 508 the computing device 100 may exchange a convolution layer with the SVM 216. A linear SVM is equivalent to a one-layer neural network. An SVM with a kernel function may be seen as a two-layer neural network. Therefore, exchange of a fully connected layer of a CNN with an SVM is possible.

In some embodiments, in block 510 the computing device 100 may use the weights from the trained layer that is being exchanged in the SVM 216. For example, the computing device 100 may use the weights for a trained fully connected layer to automatically determine the weights associated with the support vectors 218 of a SVM 216. In some embodiments, in block 512 the computing device 100 may train the SVM 216 using input from the previously trained exchanged CNN 206′. The computing device 100 may train the SVM 216 on the training data 202, using the class labels of the training data 202. This training may be similar to training the SVM 216 using feature vectors from the CNN 206 as input, as described above in connection with block 308 of FIG. 3.

In block 514, the computing device 100 converts the multiclass SVM 216 into a series of binary SVMs 216. Each binary SVM 216 makes a single classification decision, for example using the “one against all” or the “one against one” techniques. As described above, the SVM decision function ƒ(x) for the testing phase for each binary SVM 216 is shown in Equation 1.

In some embodiments, in block 516, the computing device 100 may generate a reduced set 220 of vectors for each binary SVM 216. The reduced set 220 includes vectors that may be used to generate a hyperplane to separate class members from non-class members, similar to the support vectors 218. However, each vector of the reduced set 220 is not included in the training data 202 (i.e., is not a feature vector corresponding to an item of the training data 202). The hyperplane generated by the reduced set 220 may be similar to, or in some embodiments identical to, the hyperplane generated by the support vectors 218. Because the reduced set 220 may include a much smaller number of vectors than the support vectors 218, test phase performance with the reduced set 220 may be significantly higher than with the support vectors 218. As described above, the SVM decision function ƒ(x) for the testing phase for each binary SVM 216 using the reduced set 220 is shown in Equation 2.

The computing device 100 may use any appropriate algorithm to generate the reduced set 220. For example, a vector Ψ may be determined as a function of the support vectors 218 using Equation 5, below. The vector Ψ may be approximated as a function of the reduced set vectors 220 using Equation 6, below. The reduced set method may determine the reduced set vectors 220 by minimizing the distance ∥Ψ−Ψ′∥² using Equation 7, below.

$$\begin{matrix} Ψ = {\sum }_{i = 1}^{Ns} {α}_{i} Φ ( {s}_{i} ) & ( 5 ) \\ {Ψ}^{′} = {\sum }_{i = 1}^{{N}_{z}} {α}_{i}^{RedSet} Φ ( {z}_{i} ) & ( 6 ) \\ {‖ Ψ - {Ψ}^{′} ‖}^{2} = {\sum }_{i , j = 1}^{{N}_{s}} {α}_{i} {α}_{j} K ( {s}_{i} , {z}_{j} ) + {\sum }_{i , j = 1}^{{N}_{z}} {α}_{i}^{RedSet} {α}_{j}^{RedSet} K ( {z}_{i} , {z}_{j} ) - 2 {\sum }_{i = 1}^{{N}_{s}} {\sum }_{j = 1}^{{N}_{z}} {α}_{i} {α}_{j}^{RedSet} K ( {s}_{i} , {z}_{j} ) & ( 7 )\end{matrix}$$

After generating the binary SVMs 216 (and/or generating the reduced set 220), training is complete and the method 500 may enter the testing phase. In block 518, the computing device 100 processes test data 212 with the exchanged CNN 206′ and the binary SVMs 216. The computing device 100 may input the test data 212 to the exchanged CNN 206′, which outputs a feature vector that is input to the SVM 216. The binary SVMs 216 evaluate a decision function using the corresponding support vectors 218 and/or the reduced set vectors 220. The computing device 100 may perform the calculation of Equation 1 (for the support vectors 218) or Equation 2 (for the reduced set 220), and the result may identify whether or not the input data item is included in a corresponding class. The computing device 100 may calculate the decision function for multiple binary SVMs 216 in order to support multiclass output.

In block 520, the computing device 100 generates classification output based on the output of the SVMs 216. The computing device 100 may, for example, identify a single class or otherwise process the output from the series of binary SVMs 216. After generating the classification output, the method 500 loops back to block 518 to continue processing test data 212. Of course, it should be understood that the method 500 may loop back to block 502 or otherwise restart to perform additional training.

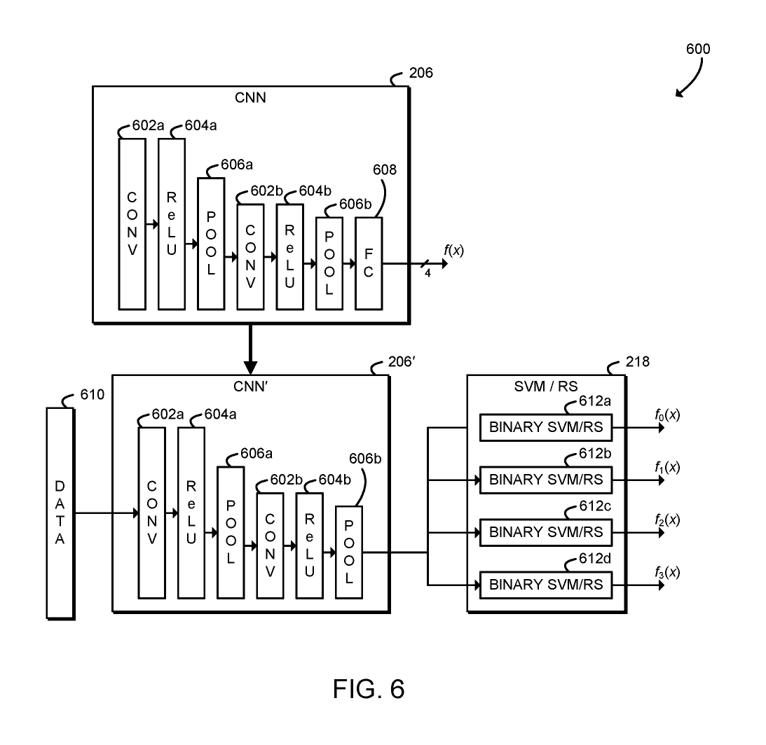

Referring now to FIG. 6, diagram 600 illustrates a network topology that may be used with the method 500 of FIG. 5. The diagram 600 illustrates a CNN 206. As shown, the illustrative CNN 206 is a multi-layer convolutional network including two convolution layers 602a, 602b, two ReLU activation layers 604a, 604b, two pooling layers 606a, 606b, and a fully connected layer 608. Of course, in other embodiments the CNN 206 may include a different number and/or type of layers). The CNN 206 is trained on the training data 202, and generates a classification function ƒ(x) from the fully connected layer 608, which illustratively provides output for four classes. As described above in connection with block 504 of FIG. 5, the fully connected layer 608 of the CNN 206 is exchanged with the SVM 216 to generate an exchanged CNN 206′. As shown, the CNN 206′ still includes the convolution layers 602, the ReLU activation layers 604, and the pooling layers 606. Although illustrated as exchanging the fully connected layer 608, it should be understood that in other embodiments, one or more other layers of the CNN 206 may be exchanged.

As shown, data 610 is input to the exchanged CNN 206′. The data 610 may include the test data 212 as described above in connection with block 518 of FIG. 5. As also described above in connection with block 518 of FIG. 5, the CNN 206′ outputs a feature vector that is input to the SVM 216. As shown, the SVM 216 includes a series of binary SVMs and/or reduced set (RS) models 612. As described above, each binary SVM/RS model 612 processes a set of support vectors 218 or reduced set vectors 220 to classify the input feature vector. Each binary SVM/RS model 612 outputs a corresponding decision function ƒᵢ(x), where x is the input data 610. Thus, the four decision functions ƒᵢ(x) output by the SVM 216 together correspond to the classification function of the original CNN 206.

It should be appreciated that, in some embodiments, the methods 300 and/or 500 may be embodied as various instructions stored on a computer-readable media, which may be executed by the processor 120, a graphical processing unit (GPU), and/or other components of the computing device 100 to cause the computing device 100 to perform the corresponding method 300 and/or 500. The computer-readable media may be embodied as any type of media capable of being read by the computing device 100 including, but not limited to, the memory 124, the data storage device 126, firmware devices, other memory or data storage devices of the computing device 100, portable media readable by a peripheral device 130 of the computing device 100, and/or other media.

### Examples

Illustrative examples of the technologies disclosed herein are provided below. An embodiment of the technologies may include any one or more, and any combination of, the examples described below.

Example 1 includes a computing device for machine learning, the computing device comprising: a feature trainer to (i) train a deep convolutional neural network (CNN) on a training data set to recognize features of the training data set, and (ii) process the training data set with the CNN to extract a plurality of feature vectors based on the training data set; a supervised trainer to train a multiclass support vector machine (SVM) on the plurality of feature vectors to classify the training data set; and an SVM manager to convert the multiclass SVM to a series of binary SVMs, wherein each binary SVM comprises a model based on the plurality of feature vectors.

Example 2 includes the subject matter of Example 1, and further comprising a classifier to: process a test data item with the CNN to extract a test feature vector based on the test data item in response to training of the deep CNN; process the test feature vector with the series of binary SVMs; and classify the test data item in response to processing of the test feature vector.

Example 3 includes the subject matter of any of Examples 1 and 2, and wherein the deep CNN comprises a plurality of convolution layers.

Example 4 includes the subject matter of any of Examples 1-3, and wherein to train the deep CNN comprises to perform unsupervised feature learning on the training data set.

Example 5 includes the subject matter of any of Examples 1-4, and wherein: the SVM manager is further to reduce a size of each of the feature vectors; and to train the multiclass SVM comprises to train the multiclass SVM in response to a reduction of the size of each of the feature vectors.

Example 6 includes the subject matter of any of Examples 1-5, and wherein the model of each binary SVM comprises a plurality of support vectors, wherein the plurality of support vectors comprises a subset of the plurality of feature vectors.

Example 7 includes the subject matter of any of Examples 1-6, and wherein the SVM manager is further to generate a reduced set of vectors for each binary SVM, wherein the model of each binary SVM includes the reduced set of vectors, and wherein the reduced set includes a smaller number of vectors than a corresponding plurality of support vectors.

Example 8 includes the subject matter of any of Examples 1-7, and wherein to generate the reduced set of vectors comprises to perform a Burges Reduced Set Vector Method (BRSM).

Example 9 includes a computing device for machine learning, the computing device comprising: a supervised trainer to train a deep convolutional neural network (CNN) on a training data set to classify the training data set, wherein the deep CNN comprises a plurality of network layers; a layer exchanger to exchange a layer of the plurality of network layers of the deep CNN with a multiclass support vector machine (SVM) to generate an exchanged CNN in response to training of the deep CNN; and an SVM manager to convert the multiclass SVM to a series of binary SVMs, wherein each binary SVM comprises a model based on the training data set.

Example 10 includes the subject matter of Example 9, and further comprising a classifier to: process a test data item with the exchanged CNN and the series of binary SVMs; and classify the test data item in response to processing of the test data item.

Example 11 includes the subject matter of any of Examples 9 and 10, and wherein the layer comprises a fully connected layer.

Example 12 includes the subject matter of any of Examples 9-11, and wherein the layer comprises a convolution layer.

Example 13 includes the subject matter of any of Examples 9-12, and wherein to exchange the layer with the multiclass SVM comprises to generate the multiclass SVM with a plurality of weights of the layer.

Example 14 includes the subject matter of any of Examples 9-13, and wherein to exchange the layer with the multiclass SVM comprises to train the multiclass SVM on an output of the exchanged CNN from the training data set to classify the training data set.

Example 15 includes the subject matter of any of Examples 9-14, and wherein the model of each binary SVM comprises a plurality of support vectors, wherein the plurality of support vectors comprises a subset of the training data set.

Example 16 includes the subject matter of any of Examples 9-15, and wherein the SVM manager is further to generate a reduced set of vectors for each binary SVM, wherein the model of each binary SVM includes the reduced set of vectors, and wherein the reduced set includes a smaller number of vectors than a corresponding plurality of support vectors.

Example 17 includes the subject matter of any of Examples 9-16, and wherein to generate the reduced set of vectors comprises to perform a Burges Reduced Set Vector Method (BRSM).

Example 18 includes a method for machine learning, the method comprising: training, by a computing device, a deep convolutional neural network (CNN) on a training data set to recognize features of the training data set; processing, by the computing device, the training data set with the CNN to extract a plurality of feature vectors based on the training data set; training, by the computing device, a multiclass support vector machine (SVM) on the plurality of feature vectors to classify the training data set; and converting, by the computing device, the multiclass SVM to a series of binary SVMs, wherein each binary SVM comprises a model based on the plurality of feature vectors.

Example 19 includes the subject matter of Example 18, and further comprising: processing, by the computing device, a test data item with the CNN to extract a test feature vector based on the test data item in response to training the deep CNN; processing, by the computing device, the test feature vector with the series of binary SVMs; and classifying, by the computing device, the test data item in response to processing the test feature vector.

Example 20 includes the subject matter of any of Examples 18 and 19, and wherein the deep CNN comprises a plurality of convolution layers.

Example 21 includes the subject matter of any of Examples 18-20, and wherein training the deep CNN comprises performing unsupervised feature learning on the training data set.

Example 22 includes the subject matter of any of Examples 18-21, and further comprising reducing, by the computing device, a size of each of the feature vectors, wherein training the multiclass SVM comprises training the multiclass SVM in response to reducing the size of each of the feature vectors.

Example 23 includes the subject matter of any of Examples 18-22, and wherein the model of each binary SVM comprises a plurality of support vectors, wherein the plurality of support vectors comprises a subset of the plurality of feature vectors.

Example 24 includes the subject matter of any of Examples 18-23, and further comprising generating, by the computing device, a reduced set of vectors for each binary SVM, wherein the model of each binary SVM includes the reduced set of vectors, and wherein the reduced set includes a smaller number of vectors than a corresponding plurality of support vectors.

Example 25 includes the subject matter of any of Examples 18-24, and wherein generating the reduced set of vectors comprises performing a Burges Reduced Set Vector Method (BRSM).

Example 26 includes a method for machine learning, the method comprising: training, by a computing device, a deep convolutional neural network (CNN) on a training data set to classify the training data set, wherein the deep CNN comprises a plurality of network layers; exchanging, by the computing device, a layer of the plurality of network layers of the deep CNN with a multiclass support vector machine (SVM) to generate an exchanged CNN in response to training the deep CNN; and converting, by the computing device, the multiclass SVM to a series of binary SVMs, wherein each binary SVM comprises a model based on the training data set.

Example 27 includes the subject matter of Example 26, and further comprising: processing, by the computing device, a test data item with the exchanged CNN and the series of binary SVMs; and classifying, by the computing device, the test data item in response to processing the test data item.

Example 28 includes the subject matter of any of Examples 26 and 27, and wherein the layer comprises a fully connected layer.

Example 29 includes the subject matter of any of Examples 26-28, and wherein the layer comprises a convolution layer.

Example 30 includes the subject matter of any of Examples 26-29, and wherein exchanging the layer with the multiclass SVM comprises generating the multiclass SVM with a plurality of weights of the layer.

Example 31 includes the subject matter of any of Examples 26-30, and wherein exchanging the layer with the multiclass SVM comprises training the multiclass SVM on an output of the exchanged CNN from the training data set to classify the training data set.

Example 32 includes the subject matter of any of Examples 26-31, and wherein the model of each binary SVM comprises a plurality of support vectors, wherein the plurality of support vectors comprises a subset of the training data set.

Example 33 includes the subject matter of any of Examples 26-32, and further comprising generating, by the computing device, a reduced set of vectors for each binary SVM, wherein the model of each binary SVM includes the reduced set of vectors, and wherein the reduced set includes a smaller number of vectors than a corresponding plurality of support vectors.

Example 34 includes the subject matter of any of Examples 26-33, and wherein generating the reduced set of vectors comprises performing a Burges Reduced Set Vector Method (BRSM).

Example 35 includes a computing device comprising: a processor; and a memory having stored therein a plurality of instructions that when executed by the processor cause the computing device to perform the method of any of Examples 18-34.

Example 36 includes one or more machine readable storage media comprising a plurality of instructions stored thereon that in response to being executed result in a computing device performing the method of any of Examples 18-34.

Example 37 includes a computing device comprising means for performing the method of any of Examples 18-34.

Example 38 includes a computing device for machine learning, the computing device comprising: means for training a deep convolutional neural network (CNN) on a training data set to recognize features of the training data set; means for processing the training data set with the CNN to extract a plurality of feature vectors based on the training data set; means for training a multiclass support vector machine (SVM) on the plurality of feature vectors to classify the training data set; and means for converting the multiclass SVM to a series of binary SVMs, wherein each binary SVM comprises a model based on the plurality of feature vectors.

Example 39 includes the subject matter of Example 38, and further comprising: means for processing a test data item with the CNN to extract a test feature vector based on the test data item in response to training the deep CNN; means for processing the test feature vector with the series of binary SVMs; and means for classifying the test data item in response to processing the test feature vector.

Example 40 includes the subject matter of any of Examples 38 and 39, and wherein the deep CNN comprises a plurality of convolution layers.

Example 41 includes the subject matter of any of Examples 38-40, and wherein the means for training the deep CNN comprises means for performing unsupervised feature learning on the training data set.

Example 42 includes the subject matter of any of Examples 38-41, and further comprising means for reducing a size of each of the feature vectors, wherein the means for training the multiclass SVM comprises means for training the multiclass SVM in response to reducing the size of each of the feature vectors.

Example 43 includes the subject matter of any of Examples 38-42, and wherein the model of each binary SVM comprises a plurality of support vectors, wherein the plurality of support vectors comprises a subset of the plurality of feature vectors.

Example 44 includes the subject matter of any of Examples 38-43, and further comprising means for generating a reduced set of vectors for each binary SVM, wherein the model of each binary SVM includes the reduced set of vectors, and wherein the reduced set includes a smaller number of vectors than a corresponding plurality of support vectors.

Example 45 includes the subject matter of any of Examples 38-44, and wherein the means for generating the reduced set of vectors comprises means for performing a Burges Reduced Set Vector Method (BRSM).

Example 46 includes a computing device for machine learning, the computing device comprising: means for training a deep convolutional neural network (CNN) on a training data set to classify the training data set, wherein the deep CNN comprises a plurality of network layers; means for exchanging a layer of the plurality of network layers of the deep CNN with a multiclass support vector machine (SVM) to generate an exchanged CNN in response to training the deep CNN; and means for converting the multiclass SVM to a series of binary SVMs, wherein each binary SVM comprises a model based on the training data set.

Example 47 includes the subject matter of Example 46, and further comprising: means for processing a test data item with the exchanged CNN and the series of binary SVMs; and means for classifying the test data item in response to processing the test data item.

Example 48 includes the subject matter of any of Examples 46 and 47, and wherein the layer comprises a fully connected layer.

Example 49 includes the subject matter of any of Examples 46-48, and wherein the layer comprises a convolution layer.

Example 50 includes the subject matter of any of Examples 46-49, and wherein the means for exchanging the layer with the multiclass SVM comprises means for generating the multiclass SVM with a plurality of weights of the layer.

Example 51 includes the subject matter of any of Examples 46-50, and wherein the means for exchanging the layer with the multiclass SVM comprises means for training the multiclass SVM on an output of the exchanged CNN from the training data set to classify the training data set.

Example 52 includes the subject matter of any of Examples 46-51, and wherein the model of each binary SVM comprises a plurality of support vectors, wherein the plurality of support vectors comprises a subset of the training data set.

Example 53 includes the subject matter of any of Examples 46-52, and further comprising means for generating a reduced set of vectors for each binary SVM, wherein the model of each binary SVM includes the reduced set of vectors, and wherein the reduced set includes a smaller number of vectors than a corresponding plurality of support vectors.

Example 54 includes the subject matter of any of Examples 46-53, and wherein the means for generating the reduced set of vectors comprises means for performing a Burges Reduced Set Vector Method (BRSM).

1. A computing device for machine learning, the computing device comprising:
a feature trainer to (i) train a deep convolutional neural network (CNN) on a training data set to recognize features of the training data set, and (ii) process the training data set with the CNN to extract a plurality of feature vectors based on the training data set;
a supervised trainer to train a multiclass support vector machine (SVM) on the plurality of feature vectors to classify the training data set; and
an SVM manager to convert the multiclass SVM to a series of binary SVMs, wherein each binary SVM comprises a model based on the plurality of feature vectors.

2. The computing device of claim 1, further comprising a classifier to:
process a test data item with the CNN to extract a test feature vector based on the test data item in response to training of the deep CNN;
process the test feature vector with the series of binary SVMs; and
classify the test data item in response to processing of the test feature vector.

3. The computing device of claim 1, wherein to train the deep CNN comprises to perform unsupervised feature learning on the training data set.

4. The computing device of claim 1, wherein:
the SVM manager is further to reduce a size of each of the feature vectors; and
to train the multiclass SVM comprises to train the multiclass SVM in response to a reduction of the size of each of the feature vectors.

5. The computing device of claim 1, wherein the SVM manager is further to generate a reduced set of vectors for each binary SVM, wherein the model of each binary SVM includes the reduced set of vectors, and wherein the reduced set includes a smaller number of vectors than a corresponding plurality of support vectors.

6. The computing device of claim 5, wherein to generate the reduced set of vectors comprises to perform a Burges Reduced Set Vector Method (BRSM).

7. One or more computer-readable storage media comprising a plurality of instructions that in response to being executed cause a computing device to:
train a deep convolutional neural network (CNN) on a training data set to recognize features of the training data set;
process the training data set with the CNN to extract a plurality of feature vectors based on the training data set;
train a multiclass support vector machine (SVM) on the plurality of feature vectors to classify the training data set; and
convert the multiclass SVM to a series of binary SVMs, wherein each binary SVM comprises a model based on the plurality of feature vectors.

8. The one or more computer-readable storage media of claim 7, further comprising a plurality of instructions that in response to being executed cause the computing device to:
process a test data item with the CNN to extract a test feature vector based on the test data item in response to training the deep CNN;
process the test feature vector with the series of binary SVMs; and
classify the test data item in response to processing the test feature vector.

9. The one or more computer-readable storage media of claim 7, wherein to train the deep CNN comprises to perform unsupervised feature learning on the training data set.

10. The one or more computer-readable storage media of claim 7, further comprising a plurality of instructions that in response to being executed cause the computing device to reduce a size of each of the feature vectors, wherein to train the multiclass SVM comprises to train the multiclass SVM in response to reducing the size of each of the feature vectors.

11. The one or more computer-readable storage media of claim 7, further comprising a plurality of instructions that in response to being executed cause the computing device to generate a reduced set of vectors for each binary SVM, wherein the model of each binary SVM includes the reduced set of vectors, and wherein the reduced set includes a smaller number of vectors than a corresponding plurality of support vectors.

12. A computing device for machine learning, the computing device comprising:
a supervised trainer to train a deep convolutional neural network (CNN) on a training data set to classify the training data set, wherein the deep CNN comprises a plurality of network layers;
a layer exchanger to exchange a layer of the plurality of network layers of the deep CNN with a multiclass support vector machine (SVM) to generate an exchanged CNN in response to training of the deep CNN; and
an SVM manager to convert the multiclass SVM to a series of binary SVMs, wherein each binary SVM comprises a model based on the training data set.

13. The computing device of claim 12, further comprising a classifier to:
process a test data item with the exchanged CNN and the series of binary SVMs; and
classify the test data item in response to processing of the test data item.

14. The computing device of claim 12, wherein the layer comprises a fully connected layer.

15. The computing device of claim 12, wherein the layer comprises a convolution layer.

16. The computing device of claim 12, wherein to exchange the layer with the multiclass SVM comprises to generate the multiclass SVM with a plurality of weights of the layer.

17. The computing device of claim 12, wherein to exchange the layer with the multiclass SVM comprises to train the multiclass SVM on an output of the exchanged CNN from the training data set to classify the training data set.

18. The computing device of claim 12, wherein the SVM manager is further to generate a reduced set of vectors for each binary SVM, wherein the model of each binary SVM includes the reduced set of vectors, and wherein the reduced set includes a smaller number of vectors than a corresponding plurality of support vectors.

19. The computing device of claim 18, wherein to generate the reduced set of vectors comprises to perform a Burges Reduced Set Vector Method (BRSM).

20. One or more computer-readable storage media comprising a plurality of instructions that in response to being executed cause a computing device to:
train a deep convolutional neural network (CNN) on a training data set to classify the training data set, wherein the deep CNN comprises a plurality of network layers;
exchange a layer of the plurality of network layers of the deep CNN with a multiclass support vector machine (SVM) to generate an exchanged CNN in response to training the deep CNN; and
convert the multiclass SVM to a series of binary SVMs, wherein each binary SVM comprises a model based on the training data set.

21. The one or more computer-readable storage media of claim 20, further comprising a plurality of instructions that in response to being executed cause the computing device to:
process a test data item with the exchanged CNN and the series of binary SVMs; and
classify the test data item in response to processing the test data item.

22. The one or more computer-readable storage media of claim 20, wherein the layer comprises a fully connected layer.

23. The one or more computer-readable storage media of claim 20, wherein to exchange the layer with the multiclass SVM comprises to generate the multiclass SVM with a plurality of weights of the layer.

24. The one or more computer-readable storage media of claim 20, wherein to exchange the layer with the multiclass SVM comprises to train the multiclass SVM on an output of the exchanged CNN from the training data set to classify the training data set.

25. The one or more computer-readable storage media of claim 20, further comprising a plurality of instructions that in response to being executed cause the computing device to generate a reduced set of vectors for each binary SVM, wherein the model of each binary SVM includes the reduced set of vectors, and wherein the reduced set includes a smaller number of vectors than a corresponding plurality of support vectors.
